(19) United States
(12) Patent Application Publication
(10) Pub. No.: US 2024/0077330 A1
(43) Pub. Date: Mar. 7, 2024

(54) METHOD AND APPARATUS FOR DETERMINING A HIGHLY ACCURATE POSITION OF A VEHICLE

(71) Applicant: Robert Bosch GmbH, Stuttgart (DE)

(72) Inventors: Jan Rohde, Stuttgart (DE); Tobias Strauss, Obersulm (DE)

(21) Appl. No.: 18/451,663

(22) Filed: Aug. 17, 2023

(30) Foreign Application Priority Data
Sep. 6, 2022 (DE) 10 2022 209 225.2

(51) Int. Cl. G01C 21/00

(52) U.S. Cl. CPC G01C 21/3848

(57) ABSTRACT

A method and a first apparatus for determining a highly accurate position of a vehicle. In the method, several localization methods for determining an initial position are performed, wherein each localization method is designed to determine a position of the vehicle with a particular uncertainty, depending on the respective localization method. A comparison of the respectively determined positions with their uncertainties is performed and the initial position is determined depending thereon. Starting from the initial position, a map is subsequently provided, which at least partially represents an environment of the vehicle. Environmental data values are sensed by means of an environmental sensor system of the vehicle. The highly accurate position of the vehicle is determined by a comparison of the sensed environmental data values to the map.

### CROSS REFERENCE

The present application claims the benefit under 35 U.S.C. § 119 of German Patent Application No. DE 10 2022 209 225.2 filed on Sep. 6, 2022, which is expressly incorporated herein by reference in its entirety.

### FIELD

The present invention inter alia relates to a method for determining a highly accurate position of a vehicle, wherein, starting from a previously determined initial position, a map is provided, and the highly accurate position of the vehicle is determined by means of a comparison of sensed environmental data values to the map.

### SUMMARY

According to an example embodiment of the present invention, the method for determining a highly accurate position of a vehicle is carried out by performing several localization methods for determining an initial position, wherein each localization method is designed to determine a position of the vehicle with a particular uncertainty, depending on the respective localization method, wherein a comparison of the respectively determined positions with their uncertainties is performed and the initial position is determined depending thereon. Furthermore, starting from the initial position, a map is subsequently provided, which at least partially represents an environment of the vehicle, wherein environmental data values are sensed by means of an environmental sensor system of the vehicle, wherein the highly accurate position of the vehicle is determined by means of a comparison of the sensed environmental data values to the map.

A vehicle herein is to be understood to mean a manually operated vehicle in accordance with SAE level 0 or an automated vehicle in accordance with one of SAE levels 1 to 5 (see SAE J3016 standard).

A localization method (GNSS locating, GSM locating, WLAN-based locating, map-based locating, etc.) herein is to be understood to mean a method which is suitable for determining a position and/or a direction of movement of a vehicle in a specified coordinate system, e.g., WGS84 coordinates, wherein the position has a certain uncertainty. From a mathematical point of view, the uncertainty may, for example, be represented as a Gaussian distribution, wherein the actually occurring uncertainty depend on the type of localization method and/or on the environment and/or further factors (weather conditions, etc.) or vary.

The corresponding localization method is carried out by means of a device which is designed for this purpose and comprised by the vehicle. Depending on the design of the vehicle, this may be a navigation system and/or a smartphone connected to the vehicle and/or another device suitable for this purpose.

A highly accurate position is understood to mean a position which is likewise accurate within a specified coordinate system, e.g., WGS84 coordinates, to such a degree that this position does not exceed a maximum permitted uncertainty. The maximum uncertainty may depend on the environment, for example. Furthermore, the maximum uncertainty can depend, for example, on whether a vehicle is operated manually or in a partially, highly or fully automated manner (corresponding to one of SAE levels 1 to 5). In principle, the maximum uncertainty is so low that a safe operation of the automated vehicle is in particular ensured. For a fully automated operation of the automated vehicle, the maximum uncertainty is, for example, in an order of magnitude of about 10 centimeters.

According to an example embodiment of the present invention, the sensing of the environmental data values is carried out, for example, in that the vehicle comprises a corresponding environmental sensor system for this purpose. An environmental sensor system is to be understood to mean at least one video sensor and/or at least one radar sensor and/or at least one lidar sensor and/or at least one ultrasonic sensor and/or at least one further sensor which is designed to sense an environment of a vehicle in the form of environmental data values. In one possible embodiment, the environmental sensor system comprises, for example, a computing unit (processor, memory, hard drive) with suitable software and/or is connected to such a computing unit.

A map is understood to mean a digital map which is present in the form of (map) data values on a storage medium. For example, the map is designed to comprise one or more map layers, wherein one map layer, for example, shows a map from the bird's eye view (course and position of roads, buildings, landscape features, etc.). This corresponds to a map of a navigation system, for example. A further map layer comprises, for example, a radar map, wherein environmental features comprised by the radar map are stored along with a radar signature. A further map layer comprises, for example, a lidar map, wherein environmental features comprised by the lidar map are stored along with a lidar signature.

In this case, the map is in particular designed as a highly accurate map which is suitable for the navigation of an automated vehicle, for example. This is, for example, to be understood to mean that the highly accurate map is designed to determine a highly accurate position of this automated vehicle and/or a trajectory for the automated vehicle by means of a comparison of stored environmental features to sensed sensor data values of the automated vehicle. To this end, the highly accurate map comprises, for example, these environmental features with highly accurate position information (coordinates).

According to an example embodiment of the present invention, the method mentioned herein may advantageously achieve the object of providing a method for localizing a vehicle. This object is achieved by means of the method according to the present invention by performing several localization methods for determining an initial position, subsequently providing, starting from the initial position, a map which at least partially represents an environment of the vehicle, and determining a highly accurate position of the vehicle by means of a comparison of the map to environmental data values. This shows the advantage that due to the several localization methods performed in parallel or in a time-delayed manner, the reliability of the localization as a whole increases due to the consistency checks by means of the comparison of the respectively determined positions with their uncertainties and errors are thus reduced. Furthermore, the time for the comparison of the sensed environmental data values and the map can thus be reduced due to the already more accurately known initial position. This also reduces the required computational effort of a control device comprised by the vehicle, etc.

Preferably, according to an example embodiment of the present invention, the initial position is determined by selecting, depending on the comparison, the position that is sufficiently accurate according to specified criteria, or by fusing, depending on the comparison, at least one subset of the determined positions and their uncertainties to form the initial position.

In this respect, “sufficiently accurate” means that ambiguity in the (subsequent) map-based localization can be ruled out. This means that the corresponding map, which at least partially represents an environment of the vehicle, is provided in such a way that the highly accurate position of the vehicle can be determined unambiguously, i.e., the comparison of the sensed environmental data values to the map can be performed unambiguously.

Preferably, according to an example embodiment of the present invention, the specified criteria are determined in real time, depending on the environment, or depending on at least one of the previously determined positions.

For example, the requirements for the initial position are less high, i.e., a greater uncertainty is permitted if there are unambiguously attributable environmental features in the environment of the vehicle. If there are relatively few environmental features that can be unambiguously attributed to a particular position or a particular area and thus to a particular environment of the vehicle, the initial position must be correspondingly more accurate in order to enable the determination of the highly accurate position.

Preferably, according to an example embodiment of the present invention, the highly accurate position is used to orient the map in vehicle coordinates.

Preferably, according to an example embodiment of the present invention, the several localization methods are performed one after the other, wherein, after each localization method performed, the respectively determined position with its uncertainty is made plausible by means of an already previously determined position and the associated uncertainty, wherein the initial position is determined to be the position that is first sufficiently accurate according to the specified criteria.

According to an example embodiment of the present invention, the apparatus, in particular a control unit, is configured to perform all steps of the method for determining a highly accurate position of a vehicle.

According to an example embodiment of the present invention, the apparatus or control unit comprises a processor, memory, a storage medium, as well as suitable software for performing the method. Furthermore, the apparatus comprises an interface for transmitting and receiving data values by means of a wired and/or wireless connection, for example with corresponding devices of vehicles (control units, communication devices, environmental sensor system, navigation system, etc.) and/or further off-board devices (server, cloud, etc.).

Furthermore provided according to the present invention is a computer program comprising instructions which, when the computer program is executed by a computer, cause the computer to perform a method according to one of the methods described herein for determining a highly accurate position of a vehicle. In one embodiment, the computer program corresponds to the software comprised by the second apparatus.

Furthermore, a machine-readable storage medium on which the computer program is stored is provided according to the present invention.

Advantageous further developments and example embodiments of the present invention are disclosed herein.

### BRIEF DESCRIPTION OF THE DRAWING

Exemplary embodiments of the present invention are illustrated in the FIGURE and explained in greater detail in the following description.

FIG. 1 shows an exemplary embodiment of the method according to an example embodiment of the present invention for determining a highly accurate position of a vehicle.

### DETAILED DESCRIPTION OF EXAMPLE EMBODIMENTS

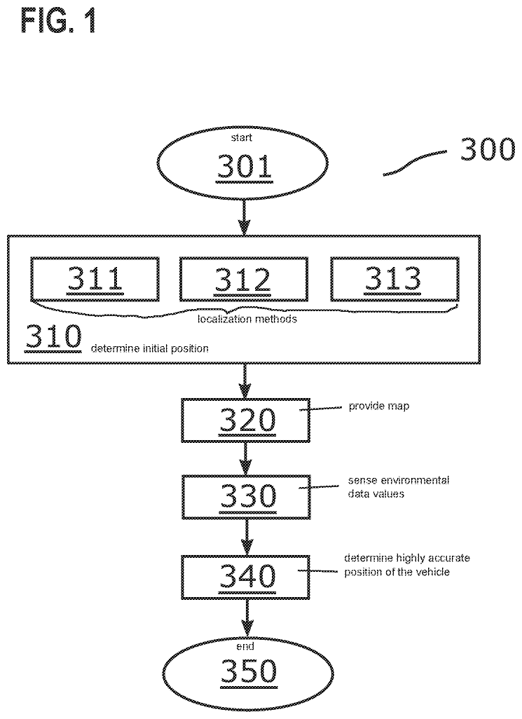

FIG. 1 shows an exemplary embodiment of a method 300 for determining 340 a highly accurate position of a vehicle. The design of the individual steps as well as the order are shown purely by way of example here and may also vary.

The method 300 starts in step 301.

In step 310, an initial position is determined by means of several localization methods 311, 312, 313. Each localization method 311, 312, 313 is designed to determine a position of the vehicle with a particular uncertainty, depending on the respective localization method 311, 312, 313, wherein a comparison of the respectively determined positions with their uncertainties is performed and the initial position is determined depending thereon.

In step 320, starting from the initial position, a map is subsequently provided, which at least partially represents an environment of the vehicle.

In step 330, environmental data values are sensed by means of an environmental sensor system of the vehicle.

In step 340, the highly accurate position of the vehicle is determined by means of a comparison of the sensed environmental data values to the map.

The method 300 ends in step 350.

What is claimed is:

1. A method for determining a highly accurate position of a vehicle, the method comprising the following steps:
performing several localization methods to determine an initial position, each localization method being configured to determine a respective position of the vehicle with a particular uncertainty, depending on the respective localization method, and a comparison of the respectively determined positions with their uncertainties is performed and the initial position is determined depending on the comparison,
subsequently providing a map, starting from the initial position, the provided map at least partially representing an environment of the vehicle;
sensing environmental data values using an environmental sensor system of the vehicle; and
determining the highly accurate position of the vehicle based on a comparison of the sensed environmental data values to the map.

2. The method according to claim 1, wherein the initial position is determined by: i) selecting, depending on the comparison, the respective determined position that is sufficiently accurate according to specified criteria, or ii) fusing, depending on the comparison, at least one subset of the respectively determined positions and their uncertainties to form the initial position.

3. The method according to claim 2, wherein the specified criteria are determined in real time, depending on the environment, or depending on at least one of the respectively determined positions.

4. The method according to claim 1, wherein the highly accurate position is used to orient the map in vehicle coordinates.

5. The method according to claim 1, wherein the several localization methods are performed one after the other, wherein, after each localization method is performed, the respectively determined position with its uncertainty is made plausible using an already previously determined position and the associated uncertainty, wherein the initial position is determined to be the respectively determined position that is first sufficiently accurate according to the specified criteria.

6. An apparatus, comprising:
a control unit, configured to determine a highly accurate position of a vehicle, the control unit configured to:
perform several localization methods to determine an initial position, each localization method being configured to determine a respective position of the vehicle with a particular uncertainty, depending on the respective localization method, and a comparison of the respectively determined positions with their uncertainties is performed and the initial position is determined depending on the comparison,
subsequently provide a map, starting from the initial position, the provided map at least partially representing an environment of the vehicle,
sense environmental data values using an environmental sensor system of the vehicle, and
determine the highly accurate position of the vehicle based on a comparison of the sensed environmental data values to the map.

7. A non-transitory machine-readable storage medium on which is stored a computer program including instructions for determining a highly accurate position of a vehicle, the instructions, when executed by a computer, causing the computer to perform the following steps:
performing several localization methods to determine an initial position, each localization method being configured to determine a respective position of the vehicle with a particular uncertainty, depending on the respective localization method, a comparison of the respectively determined positions with their uncertainties is performed and the initial position is determined depending on the comparison,
subsequently providing a map, starting from the initial position, the provided map at least partially representing an environment of the vehicle;
sensing environmental data values using an environmental sensor system of the vehicle; and
determining the highly accurate position of the vehicle based on a comparison of the sensed environmental data values to the map.
